(19) United States
(12) Patent Application Publication
(10) Pub. No.: US 2025/0010434 A1
(43) Pub. Date: Jan. 9, 2025

(54) STEEL, PROCESSING METHOD THEREOF AND SCREWDRIVER BIT

(71) Applicant: CHINA STEEL CORPORATION, KAOHSIUNG (TW)

(72) Inventors: HERNG-SHUOH JANG, KAOHSIUNG (TW); YU-TING TSAI, KAOHSIUNG (TW); CHUN-MING SU, KAOHSIUNG (TW); YING-HAO WANG, KAOHSIUNG (TW); MENG-LIN LIN, KAOHSIUNG (TW)

(21) Appl. No.: 18/675,201

(22) Filed: May 28, 2024

(30) Foreign Application Priority Data
Jul. 5, 2023 (TW) 112125099

(51) Int. Cl. B25B 15/00; C21D 1/32; C21D 6/00; C22C 38/00; C22C 38/02; C22C 38/04; C22C 38/06; C22C 38/34; C22C 38/46; C22C 38/48

(52) U.S. Cl. CPC B25B 15/002; C21D 1/32; C21D 6/004; C21D 6/005; C21D 6/008; C22C 38/001; C22C 38/002; C22C 38/02; C22C 38/04; C22C 38/06; C22C 38/34; C22C 38/46; C22C 38/48; C21D 2211/008; C22C 2202/02

(57) ABSTRACT

The present disclosure relates to a steel comprising 0.8 wt % to 0.87 wt % C; 1.5 wt % to 2.3 wt % Si; 0.5 wt % to 1.3 wt % Ni; a grain refining agent, selected from the group consisting of 0.08 wt % to 0.25 wt % V, 0.015 wt % to 0.04 wt % Nb, and a combination thereof; and the balance being Fe and inevitable impurities. The present disclosure further relates to a screwdriver bit made of the steel, and a method for processing the steel.

### FIELD OF THE INVENTION

The present disclosure relates to a steel, a method for processing the steel, and a screwdriver bit made of the steel.

### BACKGROUND OF THE INVENTION

Screwdriver bits are a major focus of the tooling industry. Durable and sturdy screwdriver bits require certain hardness, which can be affected by alloy elements of the steel thereof. Currently, depending on the steel used, the general hardness of commercially available screwdriver bits is within the range of HRC58 to HRC60. However, this is insufficient to meet demands for higher hardness. Some screwdriver bits made in Japan may have high hardness greater than HRC62 but are poor in the fatigue and impact properties due to low toughness. How to produce a screwdriver bit with a hardness greater than HRC60 or higher without sacrificing fatigue and impact characteristics through alloy design of steel and heat treatment has long been a goal pursued by manufacturers.

### SUMMARY OF THE INVENTION

The present disclosure provides a steel comprising:
0.8 wt % to 0.87 wt % C;
1.5 wt % to 2.3 wt % Si;
0.5 wt % to 1.3 wt % Ni;
a grain refining agent, selected from the group consisting of 0.08 wt % to 0.25 wt % V, 0.015 wt % to 0.04 wt % Nb, and a combination thereof; and the balance being Fe and inevitable impurities.

In an embodiment, the steel further comprises 0.3 wt % to 1.2 wt % Mn, 0.3 wt % to 1.5 wt % Cr, or a combination thereof.

In an embodiment, the steel further comprises 0.015 wt % to 0.05 wt % Al.

In an embodiment, the inevitable impurities comprise 0.01 wt % or less S, 0.02 wt % or less P, 0.01 wt % or less N, or a combination thereof.

In an embodiment, the steel does not comprise Mo.

In an embodiment, the steel comprises non-unstable residual austenite (RA). In a further embodiment, the non-unstable RA is in the form of films, and an area fraction of the non-unstable RA films in a cross section of the steel is 15% to 20%.

In an embodiment, a martensite-start temperature (Ms temperature) of the steel is 250° C. or less.

In an embodiment, a temperature at which transformation of ferrite to austenite is completed during heating (Ac3 temperature) of the steel is 850° C. or less.

The present disclosure further provides a screwdriver bit made of the steel.

The present disclosure also provides a method for processing a steel, comprising: spheroidizing annealing the steel to form a spheroidized material, wherein an Ms temperature of the spheroidized material is 250° C. or less; and heat treating the spheroidized material in a salt bath, wherein a temperature of the salt bath (Tₛₐₗₜ) is in the range of: Ms temperature−50° C.≤Tₛₐₗₜ≤Ms temperature+50° C.

### BRIEF DESCRIPTION OF DRAWINGS

FIG. 1 is a schematic view of salt bath heat treatment of a steel according to an example of the present disclosure.

FIG. 2 is a scanning electron microscope (SEM) image of a salt bath-treated steel according to an example of the present disclosure.

FIG. 3 is a transmission electron microscope (TEM) image of a salt bath-treated steel according to an example of the present disclosure.

FIG. 4 shows a comparison of the fatigue life between screwdriver bits made of a steel according to an example of the present disclosure, and other competing products.

### DETAILED DESCRIPTION OF THE INVENTION

In general, steel can undergo wire rod formation, spheroidizing, drawing (or stretching), machining, heat treatment, and electroplating to produce finished products such as screwdriver bits. The alloy design of the steel for screwdriver bits must not only consider the hardness of the final product, but also the requirements of each process step. For example, if the initial hardness of the steel is too high, the resulting annealed steel may become brittle. In addition, if the amount of alloying elements is too high, it may lead to a high hardness after spheroidizing annealing, making it easier to break during drawing. Furthermore, the alloy of the steel will also affect suitable operating temperatures of heat treatment. Other factors to be considered in include conditions during production, such as of annealing softening, cold working, and austenite transformation.

Hence, in order to meet productivity, operability and processability requirements, and cost consideration of elements used, the present disclosure provides a high-carbon microalloyed steel with high C content, high Si content, increased Ni content and low Ms temperature (martensite-start temperature). After spheroidizing, the high-carbon microalloyed steel of the present disclosure can be treated with salt bath to form products with high hardness and fatigue and impact resistances.

The present disclosure provides a steel, including:
0.8 wt % to 0.87 wt % C;
1.5 wt % to 2.3 wt % Si;
0.5 wt % to 1.3 wt % Ni;
a grain refining agent, selected from the group consisting of 0.08 wt % to 0.25 wt % V, 0.015 wt % to 0.04 wt % Nb, and a combination thereof; and
the balance being Fe and inevitable impurities.

The term “steel” may refer to an alloy formed of Fe with other elements, such as steel billets (e.g., slab, bloom, etc.) before process, finished product after (including but not limited to screwdriver bits), or any semi-finished products in various steps of the manufacturing process, as long as they meet the conditions defined by the present invention, such as having specific composition, tissue, Ms temperature and/or Ac3 temperature (transformation of ferrite to austenite is completed during heating). For example, the steel may include, but is not limited thereto, semi-finished products and finished products such as hot-rolled wire rod, spheroidized material, wire after drawing (e.g., hexagonal bar) and screwdriver bit.

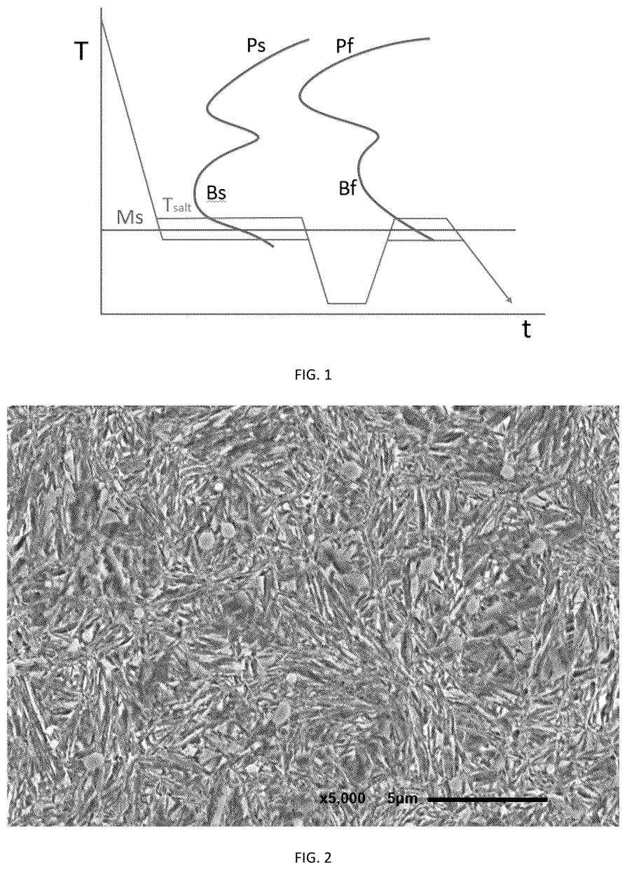

As disclosed, the alloy design of the steel must take processing temperature of heat treatment into consideration. For example, FIG. 1 is a schematic view of salt bath heat treatment of a steel according to an example of the present disclosure. In FIG. 1, “T” represents temperature, “t” represents time, “Ms” represents martensite-start temperature, “Tₛₐₗₜ” represents salt bath temperature, “Ps” and “Pf” represent start and finish temperatures of pearlite, and “Bs” and “Bf” represent start and finish temperatures of bainite. In some embodiments, the salt bath temperature “Tₛₐₗₜ” may also be referred to as salt bath isothermal transformation temperature. Since an increased salt bath temperature Tₛₐₗₜ may result in decreased hardness of the workpiece, the Tₛₐₗₜ is preferably set at a low temperature to ensure the desired hardness of the workpiece. However, the setting of the Tₛₐₗₜ depends on the characteristics of the steel, such as the Ms temperature of the steel after spheroidizing. Accordingly, the steel of the present disclosure preferably has an Ms temperature of 250° C. or less, and the salt bath temperature Tₛₐₗₜ may be set to the following.

$$Ms temperature - 50 ° C . \leq {T}_{salt} \leq Ms temperature + 50 ° C .$$

In one embodiment, the Ms temperature of the steel may be calculated by the following formula based on alloy elements:

$$Ms ( ° C . ) = 550 - 350 * C - 40 * Mn - 20 * Cr - 17 * Ni - 10 * Mo - 5 * W - 10 * Cu - 35 * V + 15 * Co + 30 * Al .$$

Based on the formula, it can be readily appreciated that C content is the key factor affecting the Ms temperature of the steel. Other than Co and Al contents which adversely affect Ms temperature, addition of other alloy elements listed here can decrease Ms temperature, such that the C content is preferably 0.8 wt % or more, and the Si content preferably 1.5 wt % or more. The high C content can sufficiently decrease Ms temperature, and high Si content can eliminate carbide precipitation, whereby a large amount of C can be retained in solid solution in steel matrix during the holding time of heat treatment to prevent softening of the steel. In another aspect, C content exceeding 0.87 wt % or Si content exceeding 2.3 wt % may make wire drawing processing more difficult and even cause wire breakage, affecting application of the steel.

Regarding steel toughness, high-carbon steel may form residual austenite (RA, also referred to as “retained austenite”) after heat treatment, and high Si content can eliminate carbide precipitation to retain the formed RA. However, under stress, unstable RA may induce phase transformation of hard martensite, adversely affecting toughness of the steel. Such issue can be solved by addition of austenite stabilizer, such as Ni, which converts unstable RA into metastable RA or stable RA (hereinafter “non-unstable RA”). The non-unstable RA can absorb strain energy to delay or suppress the generation and propagation of fatigue cracks or damage cracks, thereby enhancing toughness of high hardness steel.

Accordingly, according to one embodiment, the steel includes 0.8 wt % to 0.87 wt % C, such as 0.81 wt %, 0.82 wt %, 0.83 wt %, 0.84 wt %, 0.85 wt %, 0.86 wt %, or more, and/or 0.86 wt %, 0.85 wt %, 0.84 wt %, 0.83 wt %, 0.82 wt %, 0.81 wt %, or less. The steel includes 1.5 wt % to 2.3 wt % Si, such as 1.6 wt %, 1.7 wt %, 1.8 wt %, 1.9 wt %, 2 wt %, 2.1 wt %, 2.2 wt %, or more, and/or 2.2 wt %, 2.1 wt %, 2 wt %, 1.9 wt %, 1.8 wt %, 1.7 wt %, 1.6 wt %, or less. The steel includes 0.5 wt % to 1.3 wt % V, such as 0.6 wt %, 0.7 wt %, 0.8 wt %, 0.9 wt %, 1 wt %, 1.1 wt %, 1.2 wt %, or more, and/or 1.2 wt %, 1.1 wt %, 1 wt %, 0.9 wt %, 0.8 wt %, 0.7 wt %, 0.6 wt %, or less.

Furthermore, addition of a grain refining agent improves toughness of the steel. That is, the steel includes a grain refining agent selected from the group consisting of 0.08 wt % to 0.25 wt % V, 0.015 wt % to 0.04 wt % Nb, and a combination thereof. The steel may include one of V and Nb, or both. For example, the steel may include 0.1 wt %, 0.13 wt %, 0.16 wt %, 0.19 wt %, 0.21 wt %, 0.23 wt %, or more, and/or 0.23 wt %, 0.21 wt %, 0.19 wt %, 0.16 wt %, 0.13 wt %, 0.1 wt %, or less of V. The steel may include 0.017 wt %, 0.02 wt %, 0.025 wt %, 0.03 wt %, 0.035 wt %, 0.038 wt %, or more, and/or 0.038 wt %, 0.035 wt %, 0.03 wt %, 0.025 wt %, 0.02 wt %, 0.017 wt %, or less of Nb.

When the steel is subjected to repeated stress, the non-unstable RA (including metastable RA and stable RA) can absorb the strain energy generated by the repeated stress through different mechanisms to eliminate the generation and propagation of cracks. Among them, the metastable RA located at a fatigue crack propagation tip can absorb the strain energy generated by repeated stress and gradually transform into martensite to release such energy. This process results in transformation induced plasticity (TRIP) effect, thereby delaying and inhibiting the generation and propagation of fatigue cracks. The stable RA located at a fatigue crack propagation tip will absorb the strain energy through the mechanism of strain-induced twinning, thereby inhibiting the generation and propagation of fatigue cracks. These two types of non-unstable RA can release strain energy through delayed phase transformation or deformation twinning, thus can significantly improve the fatigue and impact resistances of the steel.

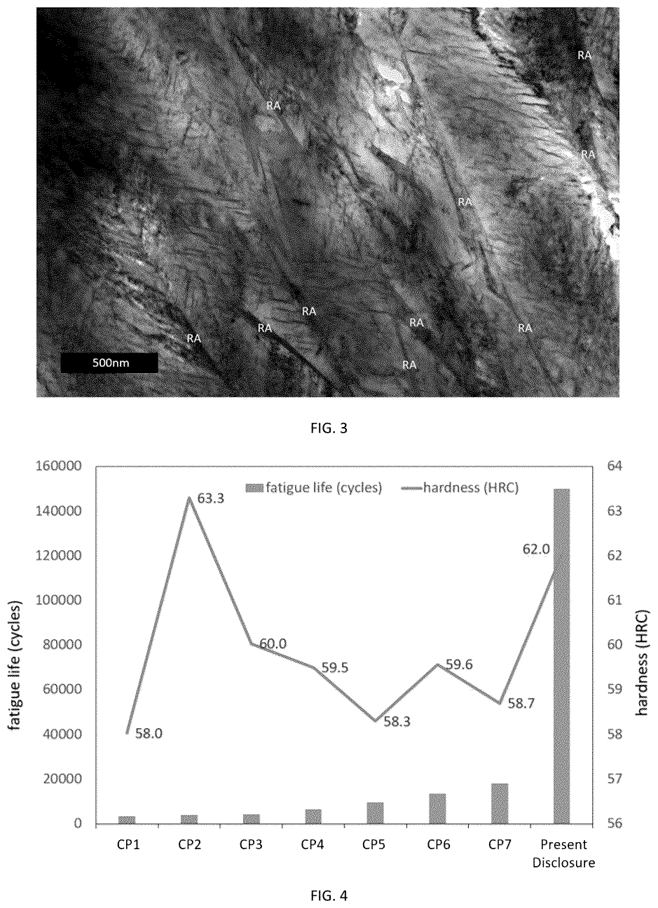

FIGS. 2 and 3 are a SEM image and a TEM image of a steel according to an example of the present disclosure after heat treatment in salt bath. In addition to nanostructured bainite, martensite and spherical carbide precipitation included in the steel matrix, the tissue also showed blocky RA and lots of film-shaped RA (i.e., in the form of films). These RA films located at the interfaces between lath-like nanostructured bainite ferrite and nanostructured bainite, between plate-like martensite and martensite, and between nanostructured bainite ferrite and martensite. The non-unstable RA films located at these interfaces can suppress or delay generation and propagation of cracks, significantly improving the fatigue and impact resistances of the steel. According to image analysis, the area fraction of the RA films (e.g., a sum of the areas of all the RA films in the image over the area of the entire steel in the image) is preferably 15% or more.

That is, in an embodiment, an area fraction of the non-unstable RA films in a cross section of the steel is 15% to 20%, such as 16%, 17%, 18%, 19%, or more, and/or 19%, 18%, 17%, 16%, or less. While not intended to be bound by any theory, it is believed that the presence of the RA films can sufficiently suppress and delay generation and propagation of cracks, significantly improving the fatigue and impact resistances of the steel. In another aspect, excessive amount of the RA films, such as an area fraction exceeding 20%, may undesirably reduce the hardness of the steel.

In addition, based on the size of the workpiece, hardening elements such as Mn, Cr and Mo may be added into the steel of the present disclosure to improve hardenability of the steel and prevent formation of pearlite during salt bath quenching. While not intended to be bound by any theory, it is believed that the addition of the hardening elements can improve the hardening depth of the heat treatment (e.g., in salt bath). The innermost portion of the finished workpiece may also be uniformly and thoroughly hardened, resulting in consistent overall hardness of the workpiece. In another aspect, excessive amount of the hardening elements may increase the processing time required for the heat treatment, increasing production time of the workpiece.

Hence, in one embodiment, the steel may further include 0.30 wt % to 1.20 wt % Mn, 0.30 wt % to 1.50 wt % Cr, or a combination thereof. That is, the steel may include one of Mn and Cr, or both. For example, the steel may include 0.4 wt %, 0.5 wt %, 0.7 wt %, 0.9 wt %, 1 wt %, 1.1 wt %, or more, and/or 1.1 wt %, 1 wt %, 0.9 wt %, 0.7 wt %, 0.5 wt %, 0.4 wt %, or less of Mn. The steel may include 0.5 wt %, 0.7 wt %, 0.9 wt %, 1.1 wt %, 1.3 wt %, or more, and/or 1.3 wt %, 1.1 wt %, 0.9 wt %, 0.7 wt %, 0.5 wt %, or less of Cr.

In one embodiment, the steel may not include Mo. The description of “not including (comprising) Mo” hereinafter means that no additional Mo is added to the steel, but it does not exclude the presence of Mo in the inevitable impurities. While not intended to be bound by any theory, it is believed that the addition of Mo may result in a high proportion of hard martensite formed in wire rods after hot rolling, making it prone to brittle fracture during subsequent packing process. Besides, the addition of Mo may also lead to excessively high hardness in the spheroidized material formed of the steel after spheroidizing, which is not conducive to subsequent wire drawing process.

In one embodiment, the steel may include Al as a deoxidizer. For example, the steel may further include 0.015 wt % to 0.05 wt % Al, such as 0.02 wt %, 0.025 wt %, 0.03 wt %, 0.035 wt %, 0.04 wt %, 0.045 wt %, or more, and/or 0.045 wt %, 0.04 wt %, 0.035 wt %, 0.03 wt %, 0.025 wt %, 0.02 wt %, or less.

In one embodiment, the evitable impurities comprise 0.01 wt % or less S, 0.02 wt % or less P, 0.01 wt % or less N, or a combination thereof.

In the manufacturing process of screwdriver bits, it may be necessary to undergo austenitizing of the steel, and the heat treatment temperature for austenitizing is preferably 30° C. to 50° C. higher than the Ac3 temperature of the steel. However, the suitable operating temperature of the current equipment is usually 850° C. to 890° C., so in one embodiment, the Ac3 temperature of the steel may be 850° C. or less, preferably 840° C. or less, to avoid affecting the flexibility of the furnace operation. In one embodiment, the Ac3 temperature is measured by an expansion meter after the steel has been spheroidized to form the spheroidized material.

The present disclosure further provides a screwdriver bit made of the steel. The steel of the present disclosure can be processed, such as through heat-treatment process for isothermal transformation, to from electric/pneumatic screwdriver bits with a stable hardness of HRC60 or even up to HRC62. The screwdriver bits can withstand a static torque fatigue test of 10.3 N·m with an average fatigue life of at least 30,000 cycles, and even exceeding 150,000 cycles without failure.

Hardness refers to Rockwell hardness test, measured using the Rockwell scale C (HRC). For example, testing can be done using standard methods such as GB/T 230.1-2004, CNS 2114, ISO 6508-1-1999 or ASTM E 18. Before sample measurement, a standard test piece is measured for calibration to ensure that the measured values do not deviate significantly from the standard values. Then, the end of the hexagonal bar of the screwdriver bit is measured. The torque fatigue test involves fixing a torque block with a PH2 cross hole at the torque output source end, and inserting a screwdriver bit with a PH2 head into the test machine. After insertion of the torque block, the hexagonal bar at the other end of the screwdriver bit is inserted into a hexagonal hole of a movable fixing seat at the other end of the test machine. A force of 15 to 20 pound is applied to the fixing seat to firmly fix the PH2 head of the screwdriver bit in the torque block hole. During the test, the torque output source applies a repeated torque of 0 to 10.3N·m to the screwdriver bit for fatigue testing.

In one embodiment, the steel of the present disclosure has high C content, high Si content and is designed with microalloying additions (e.g., including grain refining elements), which may result in poor workability of the hot-rolled material formed therefrom. In specific implementations, the hot-rolled material is preferably spheroidizing annealed to meet the requirements for cold workability, such as drawing and turning operations. The semi-finished products after processing may then be heat treated in a salt bath for isothermal transformation to increase the hardness thereof. The specific heat treatment processing method can be seen in FIG. 1.

Accordingly, the disclosure also provides a method for processing a steel, comprising: spheroidizing annealing the steel to form a spheroidized material, wherein an Ms temperature of the spheroidized material is 250° C. or less; and heat treating the spheroidized material in a salt bath, wherein a temperature of the salt bath (Tₛₐₗₜ) is in the range of:

$$Ms temperature - 50 ° C . \leq {T}_{salt} \leq Ms temperature + 50 ° C .$$

The following examples are given to illustrate the method for manufacturing the conjugated fiber of the present disclosure, but are not intended to limit the scope of the present invention.

Compositions of the steel of Examples 1 to 8 (E1 to E8) and Comparative Examples 1 to 7 (C1 to C7) are shown in Table 1. The steel was processed and spheroidized, and the Ms and Ac3 temperatures thereof measured and recorded as shown in Table 1. The steel was then processed, such as through drawing, turning and heat treatment, to form screwdriver bits for hardness and fatigue life tests.

TABLE 1

| | C | Si | Mn | P | S | Cr | Ni | Mo | Nb | V | Al | N | Ac3 | Ms |
|---|---|---|---|---|---|---|---|---|---|---|---|---|---|---|
| | (wt %) | (wt %) | (wt %) | (wt %) | (wt %) | (wt %) | (wt %) | (wt %) | (wt %) | (wt %) | (wt %) | (wt %) | (° C.) | (° C.) |
| E1 | 0.85 | 1.93 | 0.51 | 0.011 | 0.005 | 0.81 | 0.99 | — | — | 0.20 | 0.044 | 0.004 | 840 | 215 |
| E2 | 0.87 | 1.86 | 0.31 | 0.012 | 0.005 | 0.83 | 1.21 | — | — | 0.17 | 0.039 | 0.005 | 831 | 207 |
| E3 | 0.80 | 2.29 | 0.98 | 0.013 | 0.004 | 0.78 | 1.30 | — | — | 0.25 | 0.047 | 0.004 | 849 | 244 |
| E4 | 0.86 | 1.51 | 0.55 | 0.014 | 0.007 | 0.76 | 0.87 | — | — | 0.12 | 0.042 | 0.004 | 839 | 210 |
| E5 | 0.85 | 1.90 | 0.51 | 0.011 | 0.006 | 1.19 | 1.05 | — | — | 0.18 | 0.034 | 0.005 | 835 | 215 |
| E6 | 0.81 | 2.21 | 1.20 | 0.015 | 0.003 | 0.85 | 1.12 | — | — | 0.20 | 0.043 | 0.005 | 843 | 238 |
| E7 | 0.85 | 1.97 | 0.51 | 0.012 | 0.005 | 0.80 | 0.51 | — | 0.04 | — | 0.041 | 0.004 | 820 | 222 |
| E8 | 0.82 | 1.78 | 0.72 | 0.013 | 0.005 | 1.50 | 0.95 | — | 0.015 | 0.08 | 0.035 | 0.004 | 821 | 224 |
| C1 | 0.77 | 2.10 | 0.50 | 0.015 | 0.003 | 1.03 | — | 0.13 | — | 0.16 | 0.025 | 0.005 | 872 | 257 |
| C2 | 0.85 | 1.36 | 0.50 | 0.012 | 0.006 | 0.51 | 0.46 | — | — | 0.19 | 0.036 | 0.003 | 820 | 231 |
| C3 | 0.78 | 1.94 | 0.51 | 0.012 | 0.005 | 0.83 | 1.02 | — | — | 0.21 | 0.038 | 0.004 | 846 | 253 |
| C4 | 0.83 | 2.46 | 0.50 | 0.011 | 0.005 | 0.73 | 1.76 | — | — | 0.18 | 0.044 | 0.004 | 852 | 212 |
| C5 | 0.89 | 2.33 | 0.47 | 0.013 | 0.005 | 0.81 | 0.99 | — | — | 0.17 | 0.045 | 0.003 | 841 | 205 |
| C6 | 0.87 | 1.80 | 0.51 | 0.014 | 0.004 | 0.90 | 0.45 | — | — | 0.18 | 0.047 | 0.004 | 834 | 212 |
| C7 | 0.83 | 1.94 | 0.51 | 0.012 | 0.005 | 0.83 | 1.02 | — | — | 0.01 | 0.040 | 0.004 | 821 | 229 |

The screwdriver bits made of the steel of Examples 1 to 8 (E1 to E8 in Table 1) have hardness of HRC60 or more and fatigue life of 30,000 cycles or more, some of them even have hardness of HRC62 and fatigue life of 150,000 cycles or more. In addition, the steel of Examples 1 to 8 (E1 to E8 in Table 1) have Ms temperature of 250° C. or less after spheroidizing, and the addition of alloy elements meets the requirements of operability and processability of string process. In contrast, the screwdriver bits made of the steel of Comparative Examples 1 to 7 (C1 to C7 in Table 1) have hardness less than HRC60 and/or fatigue life less than 30,000 cycles.

To further validate the industrial utility of the steel in the present disclosure, the hardness and static fatigue tests are conducted on the screwdriver bit made of the steel of the present disclosure and competing products from different manufacturers (CP1 to CP7), and the results are shown in FIG. 4. The static fatigue test involves repeated torque testing at the same torque value of 10.3N·m, until the cross number 2 (PH2) head of the screwdriver bit fractured and could no longer bear the load. As shown in FIG. 4, the screwdriver bit made of the steel of the present disclosure showed a hardness of approximately HRC62 with a significantly high fatigue life, withstanding up to 150,000 cycles without failure. In contrast, the competing products were unable to simultaneously achieve both high hardness and fatigue life.

In addition, impact resistance testing was conducted on the screwdriver bits using a high-torque electric screwdriver (Milwaukee 18V lithium-ion brushless screwdriver), in which a screw is tightened by the screwdriver bit and then the screwdriver bit is subjected to further rotation to inspect for breakage. Compared to competing products that experienced breakage within 2 to 15 seconds, the screwdriver bit made of the steel of the present disclosure withstands 40 seconds, demonstrating the impact resistance characteristics of the steel of the present disclosure.

While the present disclosure has been described and illustrated with reference to specific embodiments thereof, these descriptions and illustrations are not limiting. It should be understood by those skilled in the art that various changes may be made and equivalents may be substituted without departing from the true spirit of the present disclosure as defined by the appended claims.

1. A steel, comprising:
0.8 wt % to 0.87 wt % C;
1.5 wt % to 2.3 wt % Si;
0.5 wt % to 1.3 wt % Ni;
a grain refining agent, selected from the group consisting of 0.08 wt % to 0.25 wt % V, 0.015 wt % to 0.04 wt % Nb, and a combination thereof; and
the balance being Fe and inevitable impurities.

2. The steel of claim 1, further comprising 0.3 wt % to 1.2 wt % Mn, 0.3 wt % to 1.5 wt % Cr, or a combination thereof.

3. The steel of claim 1, further comprising 0.015 wt % to 0.05 wt % Al.

4. The steel of claim 1, wherein the inevitable impurities comprise 0.01 wt % or less S, 0.02 wt % or less P, 0.01 wt % or less N, or a combination thereof.

5. The steel of claim 1, which does not comprise Mo.

6. The steel of claim 1, which comprises non-unstable residual austenite (RA).

7. The steel of claim 6, wherein the non-unstable RA is in the form of films, and an area fraction of the non-unstable RA films in a cross section of the steel is 15% to 20%.

8. The steel of claim 1, wherein a martensite-start temperature (Ms temperature) of the steel is 250° C. or less.

9. The steel of claim 1, wherein a temperature at which transformation of ferrite to austenite is completed during heating (Ac3 temperature) of the steel is 850° C. or less.

10. A screwdriver bit made of the steel of claim 1.

11. The screwdriver bit of claim 10, wherein the steel further comprises 0.3 wt % to 1.2 wt % Mn, 0.3 wt % to 1.5 wt % Cr, or a combination thereof.

12. The screwdriver bit of claim 10, wherein the steel further comprises 0.015 wt % to 0.05 wt % Al.

13. The screwdriver bit of claim 10, wherein the inevitable impurities comprise 0.01 wt % or less S, 0.02 wt % or less P, 0.01 wt % or less N, or a combination thereof.

14. The screwdriver bit of claim 10, wherein the steel does not comprise Mo.

15. The screwdriver bit of claim 10, wherein the steel comprises non-unstable residual austenite (RA).

16. A method for processing a steel, comprising:
spheroidizing annealing the steel of claim 1 to form a spheroidized material, wherein an Ms temperature of the spheroidized material is 250° C. or less; and
heat treating the spheroidized material in a salt bath, wherein a temperature of the salt bath (Tₛₐₗₜ) is in the range of:
Ms temperature−50° C.≤Tₛₐₗₜ≤Ms temperature+50° C.
